(19) United States
(12) Patent Application Publication
(10) Pub. No.: US 2014/0260961 A1
(43) Pub. Date: Sep. 18, 2014

(54) Piston Pinbore Busing With Anti-Rotation Feature

(71) Applicant: GM GLOBAL TECHNOLOGY OPERATIONS LLC, Detroit, MI (US)

(72) Inventor: Frank John REDIKER, JR., Sterling Heights, MI (US)

(73) Assignee: GM GLOBAL TECHNOLOGY OPERATIONS LLC, Detroit, MI (US)

(21) Appl. No.: 13/801,629

(22) Filed: Mar. 13, 2013

(51) Int. Cl. F02F 3/00

(52) U.S. Cl. CPC F02F 3/00
USPC 92/208

(57) ABSTRACT

A piston assembly according to an aspect of the present disclosure includes a piston and a bushing. The piston includes a piston skirt, side panels, and a piston crown. The side panels define a pin bore for receiving a wrist pin. The pin bore has an inner surface including a cylindrical section and a flat section. The bushing is fixed within the pin bore and has a hollow cylindrical body with an outer surface including a cylindrical section and a flat section. The cylindrical section of the bushing engages the cylindrical section of the pin bore. The flat section of the bushing engages the flat section of the pin bore.

### FIELD

The present disclosure relates to internal combustion engines, and more specifically, to piston pinbore bushings with an anti-rotation feature.

### BACKGROUND

This section provides background information related to the present disclosure which is not necessarily prior art.

Internal combustion engines combust an air and fuel mixture within cylinders to drive pistons, which produces drive torque. In spark-ignition engines, spark initiates combustion of an air/fuel mixture provided to the cylinders. In compression-ignition engines, compression in the cylinders combusts the air/fuel mixture provided to the cylinders.

Each of the pistons typically includes a piston crown, side panels, and a piston skirt. As the air/fuel mixture combusts within the cylinders, the force of combustion acts on the piston crown to drive the pistons. The side panels typically define a pair of pin bores for receiving a wrist pin. The wrist pin couples the pistons to connecting rods, which connect the pistons to a crankshaft. Thus, as the pistons reciprocate within the cylinders, the crankshaft rotates to produce drive torque.

### SUMMARY

This section provides a general summary of the disclosure, and is not a comprehensive disclosure of its full scope or all of its features.

A piston assembly according to an aspect of the present disclosure includes a piston and a bushing. The piston includes a piston skirt, side panels, and a piston crown. The side panels define a pin bore for receiving a wrist pin. The pin bore has an inner surface including a cylindrical section and a flat section. The bushing is fixed within the pin bore and has a hollow cylindrical body with an outer surface including a cylindrical section and a flat section. The cylindrical section of the bushing engages the cylindrical section of the pin bore. The flat section of the bushing engages the flat section of the pin bore.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first perspective view of a first piston assembly according to the present disclosure;

FIG. 2 is a second perspective view of the first piston assembly;

FIG. 3 is a side view of the first piston assembly;

FIG. 4 is a side view of a second piston assembly according to the present disclosure;

FIG. 5 is a side view of a third piston assembly according the present disclosure;

FIG. 6 is a side view of a fourth piston assembly according the present disclosure; and

FIG. 7 is a perspective view of a fifth piston assembly according to the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A piston typically includes a piston crown forming a combustion bowl, a piston skirt, and side panels defining a pair of pin bores disposed 180 degrees apart relative to a central axis of the piston. A wrist pin is inserted into the pin bores to couple the piston to a connecting rod. In some engines, bushings are inserted into the pin bores to increase the strength of the bowl edge and base of the combustion bowl.

During engine operation, the bushings can rotate within the pin bores, which can result in engine failure. For example, rotation of the bushings can cause friction between the bushings and the pin bores, which can lead to heat, noise, scuffing (i.e., a transfer of material) between the bushings and the pin and pin bores, and, ultimately, structural failure of the piston. The bushings can also move laterally relative to the pin bores, which can lead to unsupported and/or unequal pin bore loadings and, ultimately, structural failure of the piston.

A piston assembly according to the present disclosure can include an anti-rotation feature that prevents the bushings from rotating within the pin bores. In one example, the inner surfaces of the pin bores include a cylindrical section and a flat section, and the outer surfaces of the bushings include a cylindrical section and a flat section. Engagement between flat section of the outer surfaces on the bushings and the flat section of the inner surfaces on the pin bores prevents the bushings from rotating within the pin bores.

In another example, the inner surfaces of the pin bores have a non-circular (e.g., elliptical) perimeter and the outer surfaces of the bushings have a non-circular perimeter that matches the non-circular perimeter of the pin bores. Thus, the inner surfaces of the pin bores have a non-cylindrical shape and the outer surfaces of the bushings have a non-cylindrical shape. Engagement between the non-cylindrical outer surfaces of the bushings and the non-cylindrical inner surfaces of the pin bores prevents the bushings from rotating within the pin bores.

A piston assembly according to the present disclosure can include an anti-translation feature that prevents the bushings from moving laterally relative to the pin bores. For example, the inner surfaces of the pin bores and the outer surfaces of the bushings can be tapered. The inner surfaces of the pin bores can taper inward toward a first end of the pin bores to prevent the bushings from moving laterally beyond the first end. In various implementations, the inner surfaces of the pin bores and the outer surfaces of the bushings can include a dual taper to prevent the bushings from moving laterally beyond either end of the pin bores.

With reference to FIGS. 1 through 3, a piston assembly 10 includes a piston 12 and a pair of bushings 14 (only one shown). The piston 12 can be formed from a metal such as aluminum or steel. The piston 12 extends along a longitudinal axis x between a first end 16 and a second end 18. The piston 12 includes a piston crown 20, side panels 21 (only one shown), and a piston skirt 22.

The piston crown 20 forms a combustion bowl 24 and has a top land edge 26, a bowl edge 28, an upper crown surface 30 extending between the top land edge 26 and the bowl edge 28, and a bowl or base 32 disposed radially inward relative to the bowl edge 28. The top land edge 26 and the bowl edge 28 can be rounded as shown. The base 32 can have a concave or bowl shape as shown.

The piston skirt 22 includes a hollow cylindrical body 34 and extends from the piston crown 20 to the second end 18 of the piston 12. Each of the side panels 21 has an outer surface 36 and an inner surface 38, and defines a pin bore 40 that extends along a longitudinal axis y through the outer surface 36 and the inner surface 38. In addition, each of the side panels 21 has a lower surface 42 disposed at the second end 18 of the piston 12.

The two pin bores 40 are positioned 180 degrees apart from one another relative to a longitudinal axis x of the piston 12. Each of the pin bores 40 has an inner surface 44 including a cylindrical section 46 and a flat section 48. The cylindrical section 46 of the inner surface 38 has an inner diameter D1.

Each of the bushings 14 are configured to be fixed within one of the pin bores 40. The bushings 14 can be formed from a metal such as bronze, brass, nickel, copper, or a combination thereof. Each of the bushings 14 includes a hollow cylindrical body 50 and extends along the longitudinal axis y between a first end 52 and a second end 54. In addition, each of the bushings 14 has an inner surface 56 and an outer surface 58. The inner surface 56 is cylindrical and has an inner diameter D2.

The outer surface 58 includes a cylindrical section 60 and a flat section 62. The cylindrical section 60 of the outer surface 58 has an outer diameter D3. Each of the bushings 14 has a wall thickness T1 at the cylindrical section 60 and a wall thickness T2 at the flat section 62. The wall thickness T1 is equal to one-half of the difference between the inner diameter D2 and the outer diameter D3. When the bushings 14 are installed in the pin bores 40, the outer diameter D3 of the bushings 14 can be equal to the inner diameter D1 of the pin bores 40. In addition, the outer surface 58 of each of the bushings 14 can engage the inner surface 56 of each of the pin bores 40 to yield an interference or press fit.

The flat section 62 of each of the bushings 14 is configured to conform to and engage the flat section 48 of each of the pin bores 40. The engagement between the flat section 62 of the bushings 14 and the flat section 48 of the pin bores 40 prevents the bushings 14 from rotating with respect to the pin bores 40. The flat section 62 of the bushings 14 has an upper edge 64, a lower edge 66, and a height H extending between the upper edge 64 and the lower edge 66.

At the flat section 62 of the bushings 14, the inner surface 56 is cylindrical and the outer surface 58 is flat. Thus, the wall thickness at the flat section 62 varies around the perimeter of the bushings 14. The wall thickness T2 corresponds to a midpoint of the height H of the flat section 62. In the example shown, the wall thickness T2 is less than the wall thickness T1. Thus, the wall thickness of the bushings 14 increases from the wall thickness T2 at the midpoint of the height H to the wall thickness T1 at the upper and lower edges 64, 66.

The wall thickness T2 can be less than the wall thickness T1 when the flat section 62 is formed by removing material from each of the bushings 14, which may occur when the bushings 14 are formed by machining. In various implementations, such as when the bushings 14 are formed by extruding or casting, the flat section 62 can be formed by adding material to each of the bushings 14. Thus, the wall thickness of the bushings 14 can increase from the wall thickness T2 at the midpoint of the height H to the wall thickness of the bushings 14 at the upper and lower edges 64, 66, which can be greater than the wall thickness T1.

The length of each of the bushings 14 extends along the longitudinal axis y between the first end 52 and the second end 54. The length of each of the bushings 14 can vary around the perimeter of the bushings 14. For example, each of the bushings 14 can have a first length L1 at an uppermost point of the bushings 14 and a second length L2 at a lowermost point of the bushings 14. The length L1 can be greater than the length L2.

The bushings 14 can be used to increase the strength of the combustion bowl 24, particularly at the bowl edge 28 and the base 32, where the highest stresses in the combustion bowl 24 tend to occur. Stress in the combustion bowl 24 tends to be highest during a power stroke, when the force of combustion acts on the combustion bowl 24. The bushings 14 may be designed to have sufficient hoop strength to support the combustion bowl 24 under combustion loads.

The size of the flat section 62 of each of the bushings 14 can depend on the desired hoop strength of the bushings 14. The hoop strength of the bushings 14 can be affected by the outer diameter D3 of the bushings 14 and the wall thickness T1 of the bushings 14 at the cylindrical section 60 of the bushings 14. For a given wall thickness T1, the wall thickness T2 at the flat section 62 of the bushings 14 may be reduced by a greater amount as the outer diameter D3 decreases. For a given outer diameter D3, the wall thickness T2 at the flat section 62 may be reduced by a greater amount as the wall thickness T1 increases.

In one example, the outer diameter D3 of the bushings 14 is 39 millimeters (mm), the length L2 of the bushings 14 is 22 mm, and the wall thickness T1 at the cylindrical section 60 is 2.5 mm. If the wall thickness T2 at the flat section 62 is 2.0 mm, the height H of the flat section 62 is about 9 mm and the area of the flat section 62 is about 198 square millimeters (mm²). In this example, the wall thickness T2 may be reduced to 1.5 mm while maintaining adequate hoop strength in the bushings 14. Thus, the ratio of the wall thickness T1 to the wall thickness T2 may be less than or equal to 0.8 and/or within a range from 0.6 to 0.8.

Each of the bushings 14 can define a groove 68 and a notch 70, and each of the pin bores 40 can define a notch 72 that aligns with the notch 70 when the bushings 14 are inserted into the pin bores 40. The groove 68 can be configured to receive a c-clip (not shown) that prevents lateral movement of a wrist pin (not shown) relative to the pin bores 40. The notches 70, 72 provide clearance for a pry tool to pry out the c-clip out of the groove 68 to remove the wrist pin in order to disassemble the piston assembly 10, for example, during servicing.

Before assembling the piston assembly 10, the bushings 14 may be frozen to decrease the size of the bushings 14. The bushings 14 may then be inserted into the pin bores 40. As the temperature of the bushings 14 increases, the bushings 14 may expand to yield a press fit or interference fit between the outer diameter D3 of the bushings 14 and the inner diameter D1 of the pin bores 40.

Once the bushings 14 are fixed within the pin bores 40, the wrist pin may be inserted through one of the bushings 14 and a c-clip may be inserted into the groove 68 in the other one of the bushings 14. The wrist pin may then be inserted through a pin bore in a connecting rod (not shown) and into the other one of the bushings 14 until the wrist pin contacts the c-clip. A c-clip may then be inserted into the groove 68 in the first one of the bushings 14. In turn, the wrist pin is trapped between the c-clips and retained in the bushings 14.

With reference to FIG. 4, a piston assembly 100 is similar to the piston assembly 10 except for the location of the flat section 62. In the piston assembly 10, the flat section 62 is located on the side of the bushings 14, midway between the uppermost and lowermost points on the bushings 14. In contrast, in the piston assembly 100, the flat section 62 is located at the bottom of the bushings 14. Thus, the midpoint of the flat section 62 is at the lowermost point of the bushings 14.

Locating the flat section 62 at the bottom of the bushings 14 allows a section thickness T3 of the piston 12 between the pin bores 40 and the lower surface 42 to be increased. If the wall thickness T2 at the flat section 62 is less than the wall thickness T1 at the cylindrical portion 60, the section thickness T3 can be increased by the difference between the wall thickness T1 and the wall thickness T2. Increasing the section thickness T3 increases the strength of the portions of the piston 12 between the pin bores 40 and the lower surface 42.

In an example of the foregoing, a safety factor indicating the strength of the piston 12 may increase by 10 percent for every 0.5 mm increase in the section thickness T3. When the safety factor is greater than one, the piston 12 may not experience a structural failure during operation. The safety factor may be initially derived analytically and confirmed by experimentation.

With reference to FIG. 5, a piston assembly 105 is similar to the piston assembly 100 except for the relationship between the wall thicknesses T1, T2. In the piston assembly 100, the wall thickness T2 is less than the wall thickness T1, which may occur when the flat section 62 is formed by removing material from each of the bushings 14. In the piston assembly 105, the wall thickness T2 is equal to the wall thickness T1, which may occur when the flat section 62 is formed by adding material to each of the bushings 14. Thus, the wall thickness of the bushings 14 at the edges 64, 66 of the flat section 62 are greater than the wall thickness T1.

When the wall thickness T2 is equal to the wall thickness T1 and the wall thickness of the bushings 14 at the edges 64, 66 of the flat section 62 are greater than the wall thickness T1, the section thickness T3 of the piston 12 at the flat section 62 can be decreased. The section thickness T3 of the piston 12 at the flat section 62 can be decreased by the difference between the wall thickness T1 and the wall thickness of the bushings 14 at the edges 64, 66. Decreasing the section thickness T3 of the piston 12 at the flat section 62 reduces the mass of the piston 12, which may improve crankshaft bearing loads and lubrication. For example, reducing the reciprocating mass may increase the thickness of an oil film at in interface between a bearing shell and a crank journal since there is less bearing load to squeeze the oil out of the interface.

In addition, if the flat section 62 is located at the bottom of the bushings 14, as shown in FIG. 4, and the section thickness T3 is decreased to form the flat section 48 of the pin bores 40, the lower surface 42 of the piston 12 can be raised. This enables an increase in the amount of clearance between the lower surface 42 of the piston 12 and a crankshaft counterweight when the piston 12 is at its bottommost position in crank rotation, referred to as bottom dead center (BDC). In turn, more weight may be added to the crankshaft counterweight and less weight may be added to an external counterweight (e.g., a flywheel and torsional damper), which may improve engine internal balancing.

With reference to FIG. 6, a piston assembly 110 is similar to the piston assembly 10 except that the outer perimeter of each of the bushings 14 and the inner perimeter of each of the pin bores 40 are non-circular instead of circular. In other words, the outer surface 58 of each of the bushings 14 has a non-cylindrical shape and the inner surface 44 of each of the pin bores 40 has a non-cylindrical shape. In addition, the flat section 48 on each of the pin bores 40 and the flat section 62 on each of the bushings 14 are omitted. However, the engagement between the outer surface 58 of the bushings 14 and the inner surface 44 of the pin bores 40 prevents the bushings 14 from rotating within the pin bores 40.

In the example shown, the outer perimeter of each of the bushings 14 and the inner perimeter of each of the pin bores 40 are elliptical. Thus, the hollow cylindrical body 50 of each of the bushings 14 may be described as a hollow elliptical cylinder. In other examples, the outer perimeter of each of the bushings 14 and the inner perimeter of each of the pin bores 40 can have a non-circular shape such as rectangular, pentagonal, hexagonal, heptagonal or octagonal.

With reference to FIG. 7, the piston assembly 120 is similar to the piston assembly 10 except that the outer surface 58 of each of the bushings 14 tapers inward from respective midpoints M1, M2 of the lengths L1, L2 to the first and second ends 52, 54. The outer surface 58 includes a first taper 122 from the midpoints M1, M2 to the first end 52 and a second taper 124 from the midpoints M1, M2 to the second end 54. Thus, the wall thickness T1 of the bushings 14 decreases from a maximum wall thickness at the midpoints M1, M2 to a minimum wall thickness at the first and second ends 52, 54. In addition, the inner surface 44 of each of the pin bores 40 is tapered to match the first and second tapers 122, 124 on the outer surface 58 of each of the bushings 14.

The first taper 122 prevents the bushings 14 from moving laterally beyond the inner surface 38 of the piston 12. The second taper 124 prevents the bushings 14 from moving laterally beyond the outer surface 36 of the piston 12. In various implementations, the outer surface 58 of each of the bushings 14 and the inner surface 44 of each of the pin bores 40 may include a single taper instead of the double taper shown in FIG. 6. The single taper may extend along the entire length of each of the bushings 14 and each of the pin bores 40 or only a portion thereof. For example, the outer surface 58 of each of the bushings 14 may taper inward toward the first end 52 and the pin bores 40 can include a corresponding inward taper to prevent lateral movement beyond the outer surface 36 of the piston 12. In another example, the outer surface 58 of each of the bushings 14 may taper inward toward the second end 54 and the pin bores 40 can include a corresponding inward taper to prevent lateral movement beyond the inner surface 38 of the piston 12.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A piston assembly comprising:
a piston including a piston skirt, side panels, and a piston crown, the side panels defining a pin bore for receiving a wrist pin, the pin bore having an inner surface including a cylindrical section and a flat section; and
a bushing fixed within the pin bore and having a hollow cylindrical body with an outer surface including a cylindrical section and a flat section, the cylindrical section of the bushing engaging the cylindrical section of the pin bore, the flat section of the bushing engaging the flat section of the pin bore.

2. The piston assembly of claim 1 wherein the flat section of the bushing has first and second edges that extend along a length of the bushing between a first end of the bushing and a second end of the bushing.

3. The piston assembly of claim 2 wherein the bushing has a first wall thickness at the cylindrical section of the bushing and a second wall thickness at the flat section of the bushing midway between the first and second edges.

4. The piston assembly of claim 3 wherein the second wall thickness at the flat section of the bushing is different from the first wall thickness at the cylindrical section of the bushing.

5. The piston assembly of claim 4 wherein the second wall thickness at the flat section of the bushing is less than the first wall thickness at the cylindrical section of the bushing.

6. The piston assembly of claim 5 wherein a ratio of the second wall thickness at the flat section of the bushing to the first wall thickness at the cylindrical section of the bushing is less than or equal to 0.8.

7. The piston assembly of claim 6 wherein the ratio of the second wall thickness at the flat section of the bushing to the first wall thickness at the cylindrical section of the bushing is within a range from 0.6 to 0.8.

8. The piston assembly of claim 3 wherein the second wall thickness at the flat section of the bushing is equal to the first wall thickness at the cylindrical section of the bushing.

9. The piston assembly of claim 8 wherein the bushing has a third wall thickness at the first and second edges that is greater than the first wall thickness of the bushing at the cylindrical section of the bushing.

10. The piston assembly of claim 1 wherein the flat section of the pin bore is located adjacent to an end surface of the side panels.

11. The piston assembly of claim 1 wherein the flat section of the pin bore is located within a plane that is perpendicular to an end surface of the side panels.

12. The piston assembly of claim 1 wherein the cylindrical section of the pin bore has an inner diameter and the cylindrical section of the bushing has an outer diameter that is equal to the inner diameter of the pin bore.

13. The piston assembly of claim 1 wherein the bushing is fixed within the pin bore using an interference fit.

14. The piston assembly of claim 1 wherein the bushing has a first length at a first point along a perimeter of the bushing and a second length at a second point along the perimeter of the bushing that is different from the first point.

15. The piston assembly of claim 14 wherein the second length of the bushing is different from the first length of the bushing.

16. A piston assembly comprising:
a piston including a piston crown, side panels, and a piston skirt, the side panels defining a pin bore for receiving a wrist pin, the pin bore having a non-cylindrical inner surface; and
a bushing fixed within the pin bore and having a non-cylindrical outer surface engaging the non-cylindrical inner surface of the pin bore.

17. The piston assembly of claim 16 wherein the pin bore has an elliptical inner perimeter and the bushing has an elliptical outer perimeter that matches the elliptical inner perimeter of the pin bore.

18. A piston assembly comprising:
a piston including a piston skirt, side panels, and a piston crown, the side panels defining a pin bore for receiving a wrist pin, the pin bore having an inner surface; and
a bushing fixed within the pin bore, a length of the bushing extending between a first end and a second end, an outer surface of the bushing tapering inward along the length of the bushing in at least one of a first direction toward the first end and a second direction toward the second end.

19. The piston assembly of claim 18 wherein the outer surface of the bushing tapers inward along the length of the bushing in both the first direction and the second direction.

20. The piston assembly of claim 19 wherein the outer surface of the bushing tapers inward from a midpoint of the length of the bushing to the first end and tapers inward from the midpoint of the length of the bushing to the second end.
